(19) United States
(12) Patent Application Publication
(10) Pub. No.: US 2026/0362204 A1
(43) Pub. Date: Nov. 12, 2026

(54) CONDITIONAL MEASUREMENTS FOR ENERGY SAVING AT A USER EQUIPMENT

(71) Applicant: QUALCOMM Incorporated, San Diego, CA (US)

(72) Inventors: Ahmed BEDEWY, Hillsborough, NJ (US); Navid ABEDINI, Basking Ridge, NJ (US); Mohamed Fouad Ahmed MARZBAN, San Diego, CA (US); Jelena DAMNJANOVIC, Del Mar, CA (US); Tao LUO, San Diego, CA (US)

(21) Appl. No.: 19/668,726

(22) Filed: May 5, 2026

Related U.S. Application Data
(60) Provisional application No. 63/804,509, filed on May 12, 2025.

(51) Int. Cl. H04W 24/10; H04L 5/00

(52) U.S. Cl. CPC H04W 24/10; H04L 5/0051

(57) ABSTRACT

Apparatus, methods, and computer program products for wireless communication are provided. An example method may include communicating, with a network node, a conditional measurement configuration that indicates at least one measurement skipping condition or at least one measurement resume condition associated with at least one frequency portion. The example method may further include skipping or performing, based on the at least one measurement skipping condition or the at least one measurement resume condition, at least one measurement associated with at least one reference signal in the at least one frequency portion.

### CROSS REFERENCE TO RELATED APPLICATION(S)

This application claims the benefit of and priority to U.S. Provisional Application No. 63/804,509, entitled “CONDITIONAL MEASUREMENTS FOR ENERGY SAVING AT A USER EQUIPMENT” and filed on May 12, 2025, which is expressly incorporated by reference herein in its entirety.

### TECHNICAL FIELD

The present disclosure relates generally to communication systems, and more particularly, to wireless communication systems with conditional measurements at a user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor is configured to communicate, with a network node, a conditional measurement configuration that indicates at least one measurement skipping condition or at least one measurement resume condition associated with at least one frequency portion. Based at least in part on information stored in the at least one memory, the at least one processor is configured to skip or perform, based on the at least one measurement skipping condition or the at least one measurement resume condition, at least one measurement associated with at least one reference signal in the at least one frequency portion.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor is configured to communicate, with a user equipment (UE), a conditional measurement configuration that indicates at least one measurement skipping condition or at least one measurement resume condition associated with at least one frequency portion. Based at least in part on information stored in the at least one memory, the at least one processor is configured to transmit or skip transmission of, based on the at least one measurement skipping condition or the at least one measurement resume condition, at least one reference signal associated with at least one measurement in the at least one frequency portion.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating example communications between a network node and a UE, in accordance with various aspects of the present disclosure.

FIG. 5 is a flowchart of a method of wireless communication, in accordance with various aspects of the present disclosure.

FIG. 6 is a flowchart of a method of wireless communication, in accordance with various aspects of the present disclosure.

FIG. 7 is a diagram illustrating an example of a hardware implementation for an example apparatus and/or network entity, in accordance with various aspects of the present disclosure.

FIG. 8 is a diagram illustrating an example of a hardware implementation for an example network entity, in accordance with various aspects of the present disclosure.

FIG. 9 is a diagram illustrating an example of different conditions, different frequency portions, and different reference signal types, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Various aspects relate generally to wireless communication and in particular, user equipments (UEs) that may perform measurements on various frequency portions. A UE may perform measurements on different types of reference signals (RSs) for different purposes. As a first example, a UE may perform measurements on a primary synchronization signal (PSS) to detect the presence of a cell and synchronize with the timing of the cell. As a second example, a UE may perform measurements on a secondary synchronization signal (SSS) to obtain the cell-identity group and align itself with the frame boundary of the serving cell. As a third example, a UE may perform measurements on channel state information reference signal (CSI-RS) resources to estimate downlink channel quality and feedback CSI that enables the network node to adjust modulation, coding, and precoding. As a fourth example, a UE may perform measurements on the demodulation reference signal (DM-RS) embedded in a physical downlink shared channel (PDSCH) allocation to derive channel estimates that support coherent demodulation of the received data. As a fifth example, a UE may perform measurements on phase-tracking reference signal (PTRS) tones to estimate and correct phase noise, thereby maintaining symbol-phase coherence during data demodulation. As a sixth example, a UE may perform measurements on sounding reference signal (SRS) and report to the network node so that the network node can evaluate the uplink channel quality and adjust uplink transmission parameters for the UE. As a seventh example, a UE may use channel state information interference measurement (CSI-IM) to measure interference levels and report them to the base station for interference management.

Specific measurements may be performed by the UE on various frequency portions. Example aspects provided herein may enable the UE to be configured to conditionally measure suitable frequency portions to save energy and power at the UE. Additionally, the network and the UE may negotiate regarding the frequency portion(s) that the UE may perform measurements on or skip performing measurements on, and associated conditions for performing measurement or skipping of measurements. As such, the network may also be able to refrain from transmitting RSs based on whether the UE would skip measurements in those frequency portions, which may potentially save network energy and over-the-air resources as well. As a result, energy saving at the UE and the network may be achieved.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUS), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

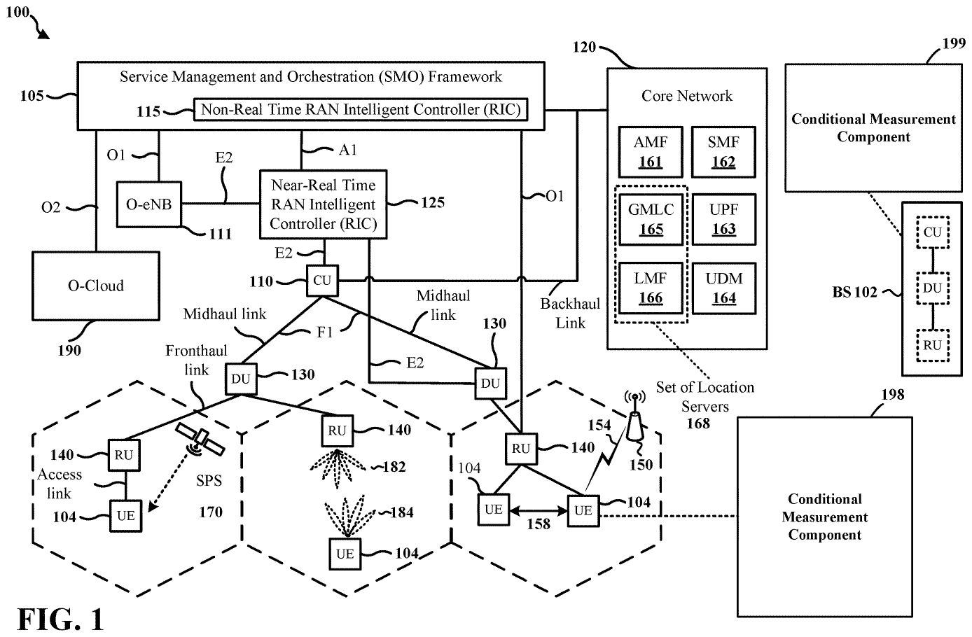

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHZ-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a conditional measurement component 198. In some aspects, the conditional measurement component 198 may be configured to communicate, with a network node, a conditional measurement configuration that indicates at least one measurement skipping condition or at least one measurement resume condition associated with at least one frequency portion. In some aspects, the conditional measurement component 198 may be further configured to skip or perform, based on the at least one measurement skipping condition or the at least one measurement resume condition, at least one measurement associated with at least one reference signal in the at least one frequency portion.

In certain aspects, the base station 102 may include a conditional measurement component 199. In some aspects, the conditional measurement component 199 may be configured to communicate, with a user equipment (UE), a conditional measurement configuration that indicates at least one measurement skipping condition or at least one measurement resume condition associated with at least one frequency portion. In some aspects, the conditional measurement component 199 may be further configured to transmit or skip transmission of, based on the at least one measurement skipping condition or the at least one measurement resume condition, at least one reference signal associated with at least one measurement in the at least one frequency portion.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

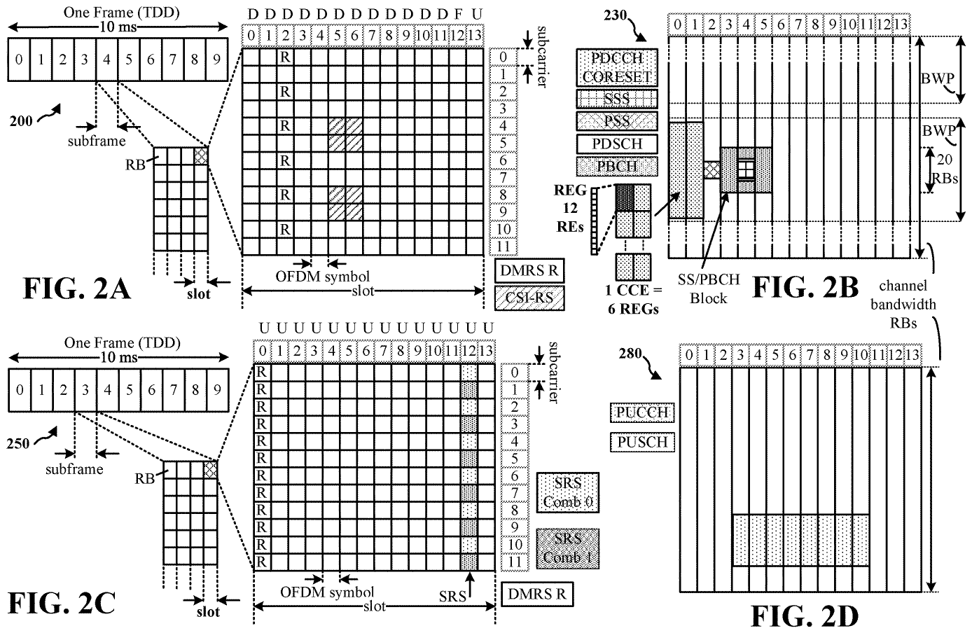

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

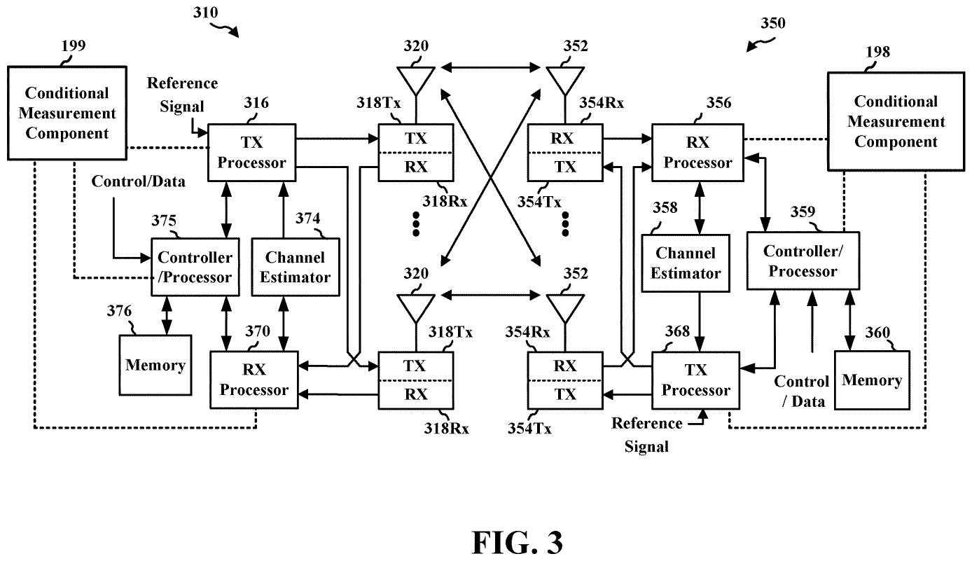

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with conditional measurement component 198 of FIG. 1.

At least one of the TX processor 316, the RX processor 370, and the controller/processor 375 may be configured to perform aspects in connection with conditional measurement component 199 of FIG. 1.

Various aspects relate generally to wireless communication and in particular, user equipments (UEs) that may perform measurements on various frequency portions. A UE may perform measurements on different types of reference signals (RSs) for different purposes. As a first example, a UE may perform measurements on a primary synchronization signal (PSS) to detect the presence of a cell and synchronize with the timing of the cell. As a second example, a UE may perform measurements on a secondary synchronization signal (SSS) to obtain the cell-identity group and align itself with the frame boundary of the serving cell. As a third example, a UE may perform measurements on channel state information reference signal (CSI-RS) resources to estimate downlink channel quality and feedback CSI that enables the network node to adjust modulation, coding, and precoding. As a fourth example, a UE may perform measurements on the demodulation reference signal (DM-RS) embedded in a PDSCH allocation to derive channel estimates that support coherent demodulation of the received data. As a fifth example, a UE may perform measurements on phase-tracking reference signal (PTRS) tones to estimate and correct phase noise, thereby maintaining symbol-phase coherence during data demodulation. As a sixth example, a UE may perform measurements on sounding reference signal (SRS) and report to the network node so that the network node can evaluate the uplink channel quality and adjust uplink transmission parameters for the UE. As a seventh example, a UE may use channel state information interference measurement (CSI-IM) to measure interference levels and report them to the base station for interference management. Such measurements may facilitate improvement on network performance, ensuring quality of service (QoS), and enhancing UE communication. The particular measurements may be reported by a UE in matrices and may be in the form of layer 1 (L1) or layer 3 (L3) reference signal received power (RSRP), reference signal received quality (RSRQ), channel quality indicator (CQI), block error rate (BLER), signal to interference and noise ratio (SINR), or the like. The measurements may include DL based or UL based measurements.

Specific measurements may be performed by the UE on various frequency portions. Example aspects provided herein may enable the UE to be configured to conditionally measure suitable frequency portions to save energy and power at the UE. Additionally, the network and the UE may negotiate regarding the frequency portion(s) that the UE may perform measurements on or skip performing measurements on, and associated conditions for performing measurement or skipping of measurements. As such, the network may also be able to refrain from transmitting RSs based on whether the UE would skip measurements in those frequency portions, which may potentially save network energy and over-the-air resources as well. As a result, energy saving at the UE and the network may be achieved while ensuring network performance, reliable connectivity, and communication efficiency.

In some aspects, the UE may skip measurement(s) (e.g., skip all measurements or skip a fraction of measurements which results in performing measurements at a reduced frequency) on at least one “frequency portion” based on at least one “measurement skipping condition” associated with the at least one frequency portion being met. As used herein, the term “frequency portion” refers to a portion defined in terms of at least one frequency component, at least one frequency subcomponent, at least one frequency band, at least one frequency subband, or the like. In some aspects, if the UE skips measurements in some frequency portion(s), the UE may transmit or receive in such frequency portion(s) based on estimations (e.g., based on previous measurements in these frequency portions or based on previous or current measurements in other frequency portions). In some aspects, the UE may also perform measurements (e.g., resume performance of measurements) on at least one frequency portion based on at least one measurement resume condition associated with the at least one frequency portion being met. In some aspects, the UE and the network may negotiate the at least one measurement resume condition, at least one measurement skipping condition, and the associated frequency portion(s) associated with each condition in the at least one measurement resume condition and the at least one measurement skipping condition.

As an example, a UE may be configured with a set of components or subcomponent that includes potential candidates for exclusion from UE measurements. Additionally, UE may be provided with a set of conditions that, if met, allow the UE to skip the measurement of these components or subcomponents. In some aspects, the UE may also be configured to negotiate/provide suggestions regarding the subcomponents or components that may be excluded from measurements or the associated conditions for skipping these measurements. In some wireless communication systems, for RRC-idle/inactive state, a UE may perform relaxed measurements (e.g., due to low-mobility, or not at cell edge) where if conditions are met, the UE may reduce the periodicity of its measurements of cells/frequencies. A UE may also skip measurement of cells in same or lower-priority frequencies, if some conditions depending on the quality/strength of the camped cell are met. In some aspects, there may be a more comprehensive set of measurement resume condition(s) or measurement skipping condition(s) for relaxing measurements in the frequency-domain (subcomponents), for both connected and idle/inactive states.

In some aspects, the measurement resume condition(s) or measurement skipping condition(s) may be configured based on a UE type (e.g., a mobile UE, a relay UE, an access point, an integrated access point (IAP), or a customer premises equipment (CPE), or a different UE type) associated with the UE. For example, based on whether the UE supports and whether the UE is configured to operate within a wide bandwidth (BW). As an example, a single cell may span a large BW including consecutive RBs. As another example, a single cell may also span a large BW including multiple non-consecutive RBs. Multiple cells may collectively span a large BW including consecutive or non-consecutive RBs. For wideband frequency selective channel, a UE may monitor, measure, and report channel/beam quality over different/smaller portions of the BW, which may cause increased energy consumption. Therefore, in particular, aspects provided herein may enable a UE operating based on a wide BW to selectively measure/skip some frequency portion(s) to save energy. As a particular example, in some aspects, a measurement skipping condition may be based on having sufficiently good measured frequency subcomponents (SCs), or sufficiently accurate estimation of other SCs, or another reason to skip such as predicted traffic at the UE being below a threshold or a channel condition below a threshold based on a previous measurement (e.g., refrain from performing measurements for frequency portion(s) having a frequency above a threshold based on the channel condition being below a threshold).

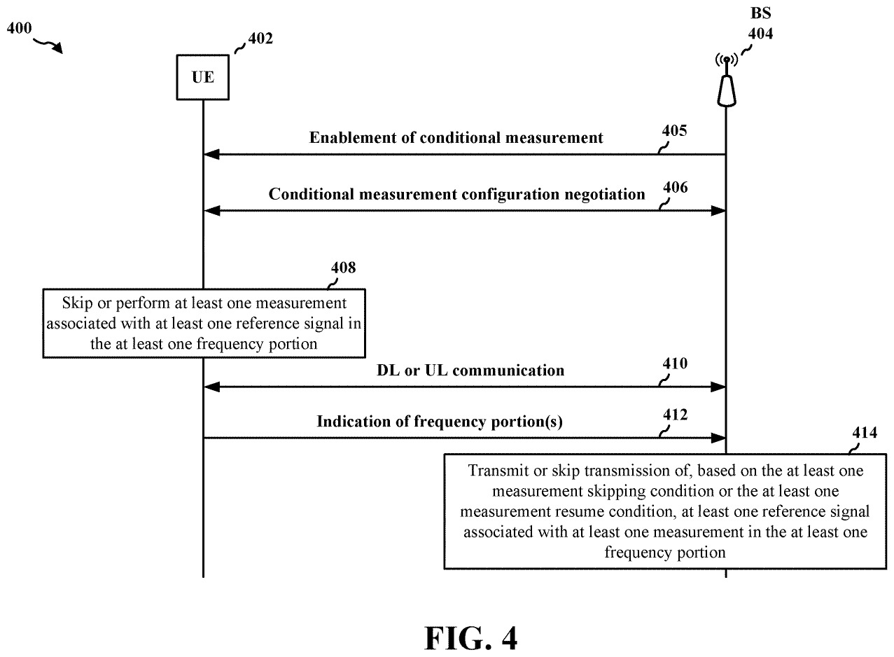

FIG. 4 is a diagram illustrating example communications between a network node 404 and a UE 402, in accordance with various aspects of the present disclosure. As illustrated in FIG. 4, at 406, the UE 402 and the network node 404 may communicate a conditional measurement configuration that indicates at least one measurement skipping condition or at least one measurement resume condition associated with at least one frequency portion. As a particular example, the network node 404 may configure the UE 402 with a set of candidate SCs, a set of candidate frequency components, or a set of candidate subbands that may be conditionally excluded from the UE's measurements. In some aspects, the SC(s) may be associated with same or different bands, cell, or component carrier (CC). In some aspects, some of the SCs may not be assigned with DL-RS for measurements and of the SCs may be assigned with DL-RS for measurements. In some aspects, some of the SCs may be assigned with DL-RS infrequently (e.g., smaller than a threshold or in some beam directions but not all beam directions). In some aspects, some of the SCs may be assigned with full/frequent DL-RS and the UE may determine to fully skip (e.g., skip all measurements) or partially skip (e.g., skip at least one measurement and perform at least one measurement at a reduced frequency) associated measurements based on fulfillment of associated measurement skipping condition(s).

In some aspects, at 406, the network node 404 may explicitly indicate the frequency portion(s) that the UE 402 may skip measuring and the associated condition(s) for each frequency portion of the frequency portion(s). In some aspects, at 406, the network node 404 may configure the UE 402 to measure a particular quantity (e.g., represented by N) of frequency portion(s). In some aspects, at 406, the network node 404 may provide the UE 402 with information that may serve as guideline in determining N (e.g., the UE 402 may pick an N that may minimize or meet a target estimation error, or based on another function). In some aspects, the network node 404 may provide the UE 402 with different condition(s) for different values of N (e.g., conditions based on a UE state such as energy level, mobility, or the like may be different for different quantity of N). In some aspects, the UE 402 may negotiate with the network node 404 or provide suggestions on the conditional measurement configuration regarding the particular frequency portion(s), the quantity of measurements, the quantity of frequency portion(s), or the associated condition(s) for each of the particular frequency portion, for each of the quantity of measurements, or the like.

In some aspects, the at least one measurement skipping condition may be condition(s) that when met, the UE 402 may skip performance of or reduce the frequency of measurements in associated frequency portion(s). The at least one measurement resume condition may be condition(s) that when met, the UE 402 may perform or increase frequency of measurements in associated frequency portion(s). In some aspects, the at least one measurement skipping condition and the at least one measurement resume condition may be defined per frequency portion (e.g., per SC) or per a set of frequency portions (e.g., all or some SCs supported by the UE). In some aspects, the at least one measurement skipping condition and the at least one measurement resume condition may be defined per RS type (e.g., skip measurement of SSS but measure PSS on the same SC). As one particular example, a particular measurement skipping condition may be defined to be associated with skipping measurements associated with at least one particular frequency portion for at least one particular RS type.

Additionally, each condition or the conditional measurement configuration as a whole may be valid for a particular associated time period, one or more particular areas, and one or more particular UE types. Additionally, each condition or the conditional measurement configuration as a whole may be reconfigurable or configurable to have a default value before signaling between the network node 404 and the UE 402. As a particular example, each respective measurement skipping condition may be defined to be associated with skipping measurements (or reduce frequency of measurements) associated with at least one respective frequency portion for at least one respective RS type, and may be associated with a respective time period and a respective UE type. One or more of the UE type(s), the area(s), the time period, the RS type(s), the frequency portion(s), may be defined per condition, per multiple conditions, or per the conditional measurement configuration as a whole.

In some aspects, condition(s) to skip/perform/reduce the frequency of SCs measurements (measurement skipping condition(s) or measurement resume condition(s)) may be based on a variety of factors. A first example factor may be the accuracy and sensitivity of the estimation relative to the measurement frequency. A second example factor may be prior measurements on the frequency portion(s). For example, a UE may be provided with a threshold for the SCs quality. If the filtered, average, instantaneous, or raw quality surpasses, drops below, or deviates from the threshold (instantaneously, or for a specified duration and/or for at least/at most N occasions), the UE may start skipping measurements of one or more SCs. Conversely, if measurements are already being skipped, the UE may resume measuring one or more of these SCs.

A third factor may be quality or quantity of frequency portion(s) being sufficient. For example, the UE may skip measuring certain SCs if it has a sufficient amount of other measured SCs or sufficiently accurate estimation of SCs excluded from measurements. A fourth factor may be correlation between SCs, where correlation may be determine based on RSRP, pathloss, used antenna/ports at network node 404 or UE 402, the delta between measured metrics remains same or within a range, or the like. For example, the UE 402 may be provided with a threshold. If the correlation goes beyond this threshold, the UE 402 may skip measurements of one or more SCs; otherwise, the UE 402 may not skip the measurements.

A fifth factor may be based on estimation quality of skipped measurements. For example, the UE 402 may start measuring the skipped SCs if the estimation error(s) exceeds a certain threshold (e.g., error(s) may be defined across all/set of SCs or per SC). Thresholds also can be defined across all/set of SCs or per SC. In some aspects, the network node 404 may transmit sporadic RSs on the unmeasured SCs to help UEs to assess the quality of its estimation, and the UE 402 may measure the sporadic RSs. In some aspects, conditions may be based on some indication from the network node 404. For example, the UE 402 may initially share its SCs measurements, and the network node 404 may accordingly indicate: (1) which additional unmeasured SCs the UE may measure, (2) if and which already measured SCs may be skipped, (3) reducing/increasing the number (N) of SCs that may be measured, or (4) changing the frequency of measurements of one or more SCs or the like. In some aspects, a sixth factor may be based on a UE status, such mobility, energy state, whether the UE is overheating (e.g., a temperature status), a UE location, expected traffic at the UE, QoS related information, or the like. As an example, if the UE is at cell-edge, then it may skip measuring other SCs. As another example, if the UE has low power, it may start skipping/reducing the frequency of measurements.

In some aspects, when the UE 402 decides to start measuring the unmeasured SCs, stops measuring some SCs, or measuring some SCs with a reduced periodicity, the UE may conditionally transmit an indication to report the measurement status to the network node 404, where the network node 404 may accordingly assign more frequent RSs for the frequency portions that the UE may measure and release (e.g., reduce the periodicity of or disassociate) RSs dedicated to SCs that the UE will stop measuring (e.g., or reduce periodicity of measurements).

In some aspects, the UE 402 may negotiate/suggest which SC to measure/skip where the UE 402 may explicitly indicate which SCs it would use (e.g., as suggestion) to perform measurement on or skip measuring. In some aspects, the UE 402 may omit reporting to the network node 404 its decision to skip measurements and can directly report its estimated measurements. In some aspects, if the UE 402 reports its decision, network node 404 may reply with approval, rejection, or with an update to the UE 402's negotiations/suggestions. In some aspects, the absence of network node 404 replay may implicitly indicate network node 404 approval.

In some aspects, the network node 404 may provide the UE 402 with some guidelines regarding how to choose SCs to perform/skip measuring. For example, the network node 404 can indicate to UE that its choice may meet certain QoS such as minimizing/bounding the estimation error (e.g., some threshold on the estimation error may be indicated per-SC, per group of SC, or for all SCs and may depend on the quality of the SC, and/or other SCs), reducing resource (RS) usage, adhering to energy constraints for both UE and network node 404, minimal effect on throughput, or the like. In some aspects, the network node 404 may also indicate to the UE402 some SCs that the UE 402 cannot skip measuring, which may be referred to as anchor SCs. In some aspects, the network node 404 may also provide additional information regarding the SCs such as TX power, BW, quantity of TX ports, or the like, that may affect UE decision. In some aspects, the network node 404 may also provide UE with conditions that if met, the UE may start its negotiation/suggestion.

In some aspects, the network node 404 may provide the UE 402 with configuration(s) or condition(s) via dedicated RRC signaling or a broadcast message (e.g., SIB, other system information, UE-specific broadcast configuration, or the like). In some aspects, configuration or reconfiguration may be autonomous/implicit (based on reconfigurations) or explicitly based on an index to a set of preconfigured set of parameters (configured sets of subcomponents/RSs and associated conditions).

In some aspects, the configuration may be provided in a SIB or dedicated RRC signaling. In some aspects, the UE 402 may be provided with one or multiple sets of configurations. When multiple sets of configurations are provided, a follow-up DL signal may indicate the index of the configuration that the UE 402 may use. In some aspects, the network node 404 may explicitly indicate (e.g., at 405) to the UE when to start and end the use of conditional skipping or resume based on paging, dedicated signal, SI, DCI, or the like. In some aspects, the indication may be specific to a single UE, a group of UEs, area specific, time specific, or the like.

In some aspects, UE negotiation/suggestion/report may be via a dedicated RRC signal, PUCCH, PUSCH, or the like. In some aspects, the UE 402 may also transmit a message (e.g., a medium access control (MAC) control element (MAC-CE) message or a similar message) that includes the SC index associated with a decision to skip/perform measurements, estimated value, estimation error, or the like. In some aspects, UE may explicitly or implicitly indicate its support for that feature via dedicated RRC signal or any other simple UL signal (may be implicitly indicated by UE type).

At 408, based on the configuration, the UE 402 may skip or perform, based on the at least one measurement skipping condition or the at least one measurement resume condition, at least one measurement associated with at least one reference signal in the at least one frequency portion. At 410, the UE 402 may still communicate with the network node 404 on the at least one frequency portion on which the UE 402 skipped measurements. At 412, the UE 402 may indicate, to the network node 404, the at least one frequency portion on which the UE 402 has skipped measurements (e.g., via an explicit indication or implicitly based on content of measurement report). In some aspects, at 414, the network node 404 may transmit or skip transmission of, based on the frequency portion(s) where the UE 402 has skipped measurement or measured according to the at least one measurement skipping condition or the at least one measurement resume condition, at least one reference signal associated with at least one measurement in the at least one frequency portion.

In some aspects, the conditional skipping or resume mechanism may be applied in connection with UE collaboration. In some aspects, the network node 404 may provide the UE 402 with two different sets of SCs to exclude from measurements as well as associated conditions. The network node 404 may instruct the UE 402 to use the first set if the UE 402 will rely on its own measurement, while the UE 402 may use the second set if the UE will rely on its own measurement as well as other measurements from other collaborated UEs. In some aspects, if the network node 404 is aware of the collaborated UEs, or the collocation of one or more UE, the network node 404 may use this collocation/collaboration information in determining the suitable set of SCs to be excluded from measurements by each UE. In some aspects, if collaborated UEs share measurements, they can coordinate with each other (e.g., by avoid duplicate measurements of shared SCs and share information about associated SCs (such as correlation between different SCs, frequency bands, etc.) to help each other to accurately determine which SC to measure).

In some aspects, depending on whether the skipped measurements are DL or UL measurements and whether the RSs are DL or UL RSs, the role of the UE and the network node may be flipped in the operations recited in connection with FIG. 4.

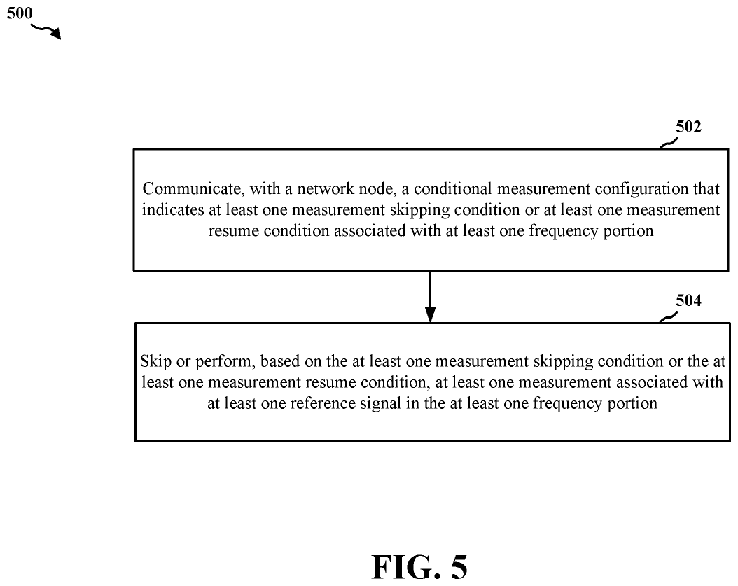

FIG. 5 is a flowchart 500 of a method of wireless communication. The method may be performed by a UE (e.g., the UE 104, the UE 402; the apparatus 704).

At 502, the UE may communicate, with a network node, a conditional measurement configuration that indicates at least one measurement skipping condition or at least one measurement resume condition associated with at least one frequency portion. For example, the UE 402 may communicate (e.g., at 406), with a network node 404, a conditional measurement configuration that indicates at least one measurement skipping condition or at least one measurement resume condition associated with at least one frequency portion. In some aspects, 502 may be performed by conditional measurement component 198.

At 504, the UE may skip or perform, based on the at least one measurement skipping condition or the at least one measurement resume condition, at least one measurement associated with at least one reference signal in the at least one frequency portion. For example, the UE 402 may skip or perform (e.g., at 408), based on the at least one measurement skipping condition or the at least one measurement resume condition, at least one measurement associated with at least one reference signal in the at least one frequency portion. In some aspects, 504 may be performed by conditional measurement component 198.

In some aspects, the conditional measurement configuration includes the at least one measurement skipping condition. In some aspects, the UE may skip, based on the at least one measurement skipping condition, the at least one measurement associated with the at least one reference signal in the at least one frequency portion.

In some aspects, the UE may receive a downlink communication or transmit an uplink communication in the at least one frequency portion.

In some aspects, the at least one measurement skipping condition or the at least one measurement resume condition is based on at least one of: an accuracy or a sensitivity associated with the at least one measurement relative to a measurement frequency associated with the at least one frequency portion, one or more prior measurements associated with the at least one frequency portion, a quantity of a set of other measured frequency portions associated with the UE, a correlation between the at least one frequency portion and the set of other measured frequency portions associated with the UE, an estimation quality associated with the at least one measurement, or a UE status. In some aspects, the UE status includes at least one of: an energy state associated with the UE, a mobility associated with the UE, an expected traffic at the UE, a quality of service associated with the UE, or a UE temperature status.

In some aspects, the conditional measurement configuration includes the at least one measurement skipping condition. In some aspects, the UE may skip, based on the at least one measurement skipping condition, the at least one measurement associated with the at least one reference signal in the at least one frequency portion and perform at least one other measurement at a reduced frequency in the at least one frequency portion. In some aspects, the conditional measurement configuration includes the at least one measurement resume condition. In some aspects, the UE may resume, based on the at least one measurement resume condition, performance of the at least one measurement associated with the at least one reference signal in the at least one frequency portion.

In some aspects, each measurement skipping condition of the at least one measurement skipping condition or each measurement resume condition of the at least one measurement resume condition is associated with at least one respective frequency portion of the at least one frequency portion or all of the at least one frequency portion, at least one respective reference signal type associated with the at least one reference signal, or an area associated with the UE.

In some aspects, the at least one respective reference signal type corresponds to at least one of: a primary synchronization signal (PSS), a secondary reference signal (SSS), a channel state information reference signal (CSI-RS), a demodulation reference signal (DM-RS), a phase tracking reference signal (PTRS), a sounding reference signal (SRS), or a channel state information interference measurement (CSI-IM).

In some aspects, each measurement skipping condition of the at least one measurement skipping condition or each measurement resume condition of the at least one measurement resume condition is specific to a respective area associated with the UE, a respective UE type, or a time period. In some aspects, the respective UE type corresponds to a mobile UE, a relay UE, an access point, an integrated access point (IAP), or a customer premises equipment (CPE).

In some aspects, to communicate the conditional measurement configuration, the UE may receive, from the network node, the conditional measurement configuration in a system information block (SIB) or a radio resource control (RRC) signaling.

In some aspects, to communicate the conditional measurement configuration, the UE may transmit, to the network node a capability indication that indicates a support associated with the at least one measurement skipping condition or the at least one measurement resume condition.

In some aspects, to communicate the conditional measurement configuration, the UE may transmit, to the network node, a proposal for the conditional measurement configuration and receive, from the network node, receive, from the network node, a confirmation, a different proposal for the conditional measurement configuration, or a denial in response to the proposal.

In some aspects, the conditional measurement configuration further includes at least one location of the at least one frequency portion and a mapping between the at least one location and at least one of: (1) the at least one measurement skipping condition or (2) the at least one measurement resume condition. In some aspects, the conditional measurement configuration further includes a quantity associated with the at least one frequency portion. In some aspects, the conditional measurement configuration further includes information associated with a derivation of the at least one frequency portion, where the information includes one or more frequency portions to be excluded from skipping, at least one measurement estimation threshold, at least one transmission parameter associated with the at least one reference signal, or at least one quality of service (QoS) indication. In some aspects, the at least one frequency portion includes at least one frequency component, at least one frequency subcomponent, at least one frequency band, or at least one frequency subband.

In some aspects, depending on whether the skipped measurements are DL or UL measurements and whether the RSs are DL or UL RSs, the role of the UE and the network node may be flipped in the operations recited in connection with FIG. 5.

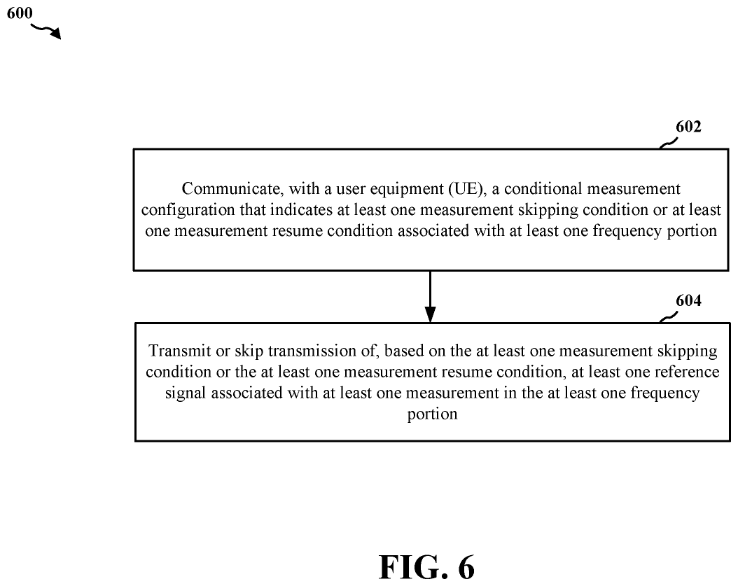

FIG. 6 is a flowchart 600 of a method of wireless communication. The method may be performed by a network entity (e.g., the base station 102, the network node 404, the network entity 702, the network entity 802).

At 602, the network entity may communicate, with a user equipment (UE), a conditional measurement configuration that indicates at least one measurement skipping condition or at least one measurement resume condition associated with at least one frequency portion. For example, the network node 404 may communicate (e.g., at 406), with a user equipment (UE), a conditional measurement configuration that indicates at least one measurement skipping condition or at least one measurement resume condition associated with at least one frequency portion. In some aspects, 602 may be performed by conditional measurement component 199.

At 604, the network entity may transmit or skip transmission of, based on the at least one measurement skipping condition or the at least one measurement resume condition, at least one reference signal associated with at least one measurement in the at least one frequency portion. For example, the network node 404 may transmit or skip transmission of (e.g., at 414), based on the at least one measurement skipping condition or the at least one measurement resume condition, at least one reference signal associated with at least one measurement in the at least one frequency portion. In some aspects, 604 may be performed by conditional measurement component 199.

In some aspects, depending on whether the skipped measurements are DL or UL measurements and whether the RSs are DL or UL RSs, the role of the UE and the network node may be flipped in the operations recited in connection with FIG. 6.

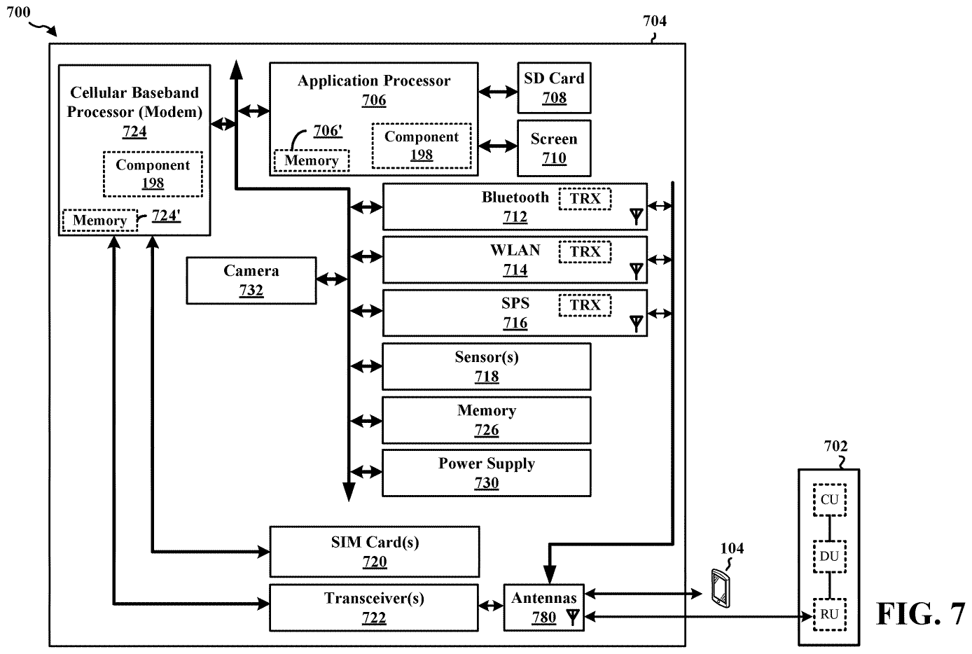

FIG. 7 is a diagram 700 illustrating an example of a hardware implementation for an apparatus 704. The apparatus 704 may be a UE, a component of a UE, or may implement UE functionality. In some aspects, the apparatus 704 may include at least one cellular baseband processor 724 (also referred to as a modem) coupled to one or more transceivers 722 (e.g., cellular RF transceiver). The cellular baseband processor(s) 724 may include at least one on-chip memory 724′. In some aspects, the apparatus 704 may further include one or more subscriber identity modules (SIM) cards 720 and at least one application processor 706 coupled to a secure digital (SD) card 708 and a screen 710. The application processor(s) 706 may include on-chip memory 706′. In some aspects, the apparatus 704 may further include a Bluetooth module 712, a WLAN module 714, an SPS module 716 (e.g., GNSS module), one or more sensor modules 718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 726, a power supply 730, and/or a camera 732. The Bluetooth module 712, the WLAN module 714, and the SPS module 716 may include an on-chip transceiver (TRX) (or in some cases, just a receiver (RX)). The Bluetooth module 712, the WLAN module 714, and the SPS module 716 may include their own dedicated antennas and/or utilize the antennas 780 for communication. The cellular baseband processor(s) 724 communicates through the transceiver(s) 722 via one or more antennas 780 with the UE 104 and/or with an RU associated with a network entity 702. The cellular baseband processor(s) 724 and the application processor(s) 706 may each include a computer-readable medium/memory 724′, 706′, respectively. The additional memory modules 726 may also be considered a computer-readable medium/memory. Each computer-readable medium/memory 724′, 706′, 726 may be non-transitory. The cellular baseband processor(s) 724 and the application processor(s) 706 are each responsible for general processing, including the execution of software stored on the computer-readable medium/memory. The software, when executed by the cellular baseband processor(s) 724/application processor(s) 706, causes the cellular baseband processor(s) 724/application processor(s) 706 to perform the various functions described supra. The computer-readable medium/memory may also be used for storing data that is manipulated by the cellular baseband processor(s) 724/application processor(s) 706 when executing software. The cellular baseband processor(s) 724/application processor(s) 706 may be a component of the UE 350 and may include the at least one memory 360 and/or at least one of the TX processor 368, the RX processor 356, and the controller/processor 359. In one configuration, the apparatus 704 may be at least one processor chip (modem and/or application) and include just the cellular baseband processor(s) 724 and/or the application processor(s) 706, and in another configuration, the apparatus 704 may be the entire UE (e.g., see UE 350 of FIG. 3) and include the additional modules of the apparatus 704.

As discussed supra, the conditional measurement component 198 may be configured to communicate, with a network node, a conditional measurement configuration that indicates at least one measurement skipping condition or at least one measurement resume condition associated with at least one frequency portion. In some aspects, the conditional measurement component 198 may be further configured to skip or perform, based on the at least one measurement skipping condition or the at least one measurement resume condition, at least one measurement associated with at least one reference signal in the at least one frequency portion. The conditional measurement component 198 may be within the cellular baseband processor(s) 724, the application processor(s) 706, or both the cellular baseband processor(s) 724 and the application processor(s) 706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 704 may include a variety of components configured for various functions. In one configuration, the apparatus 704, and in particular the cellular baseband processor(s) 724 and/or the application processor(s) 706, may include means for communicating, with a network node, a conditional measurement configuration that indicates at least one measurement skipping condition or at least one measurement resume condition associated with at least one frequency portion. In some aspects, the apparatus 704 may include means for skipping or performing, based on the at least one measurement skipping condition or the at least one measurement resume condition, at least one measurement associated with at least one reference signal in the at least one frequency portion. In some aspects, the apparatus 704 may include means for skipping, based on the at least one measurement skipping condition, the at least one measurement associated with the at least one reference signal in the at least one frequency portion. In some aspects, the apparatus 704 may include means for receiving a downlink communication or transmitting an uplink communication in the at least one frequency portion. In some aspects, the apparatus 704 may include means for skipping, based on the at least one measurement skipping condition, the at least one measurement associated with the at least one reference signal in the at least one frequency portion and performing at least one other measurement at a reduced frequency in the at least one frequency portion. In some aspects, the apparatus 704 may include means for resuming, based on the at least one measurement resume condition, performance of the at least one measurement associated with the at least one reference signal in the at least one frequency portion. In some aspects, the apparatus 704 may include means for receiving, from the network node, the conditional measurement configuration in a system information block (SIB) or a radio resource control (RRC) signaling. In some aspects, the apparatus 704 may include means for transmitting, to the network node a capability indication that indicates a support associated with the at least one measurement skipping condition or the at least one measurement resume condition. In some aspects, the apparatus 704 may include means for transmitting, to the network node, a proposal for the conditional measurement configuration. In some aspects, the apparatus 704 may include means for receiving, from the network node, receive, from the network node, a confirmation, a different proposal for the conditional measurement configuration, or a denial in response to the proposal. The means may be the component 198 of the apparatus 704 configured to perform the functions recited by the means. As described supra, the apparatus 704 may include the TX processor 368, the RX processor 356, and the controller/processor 359. As such, in one configuration, the means may be the TX processor 368, the RX processor 356, and/or the controller/processor 359 configured to perform the functions recited by the means.

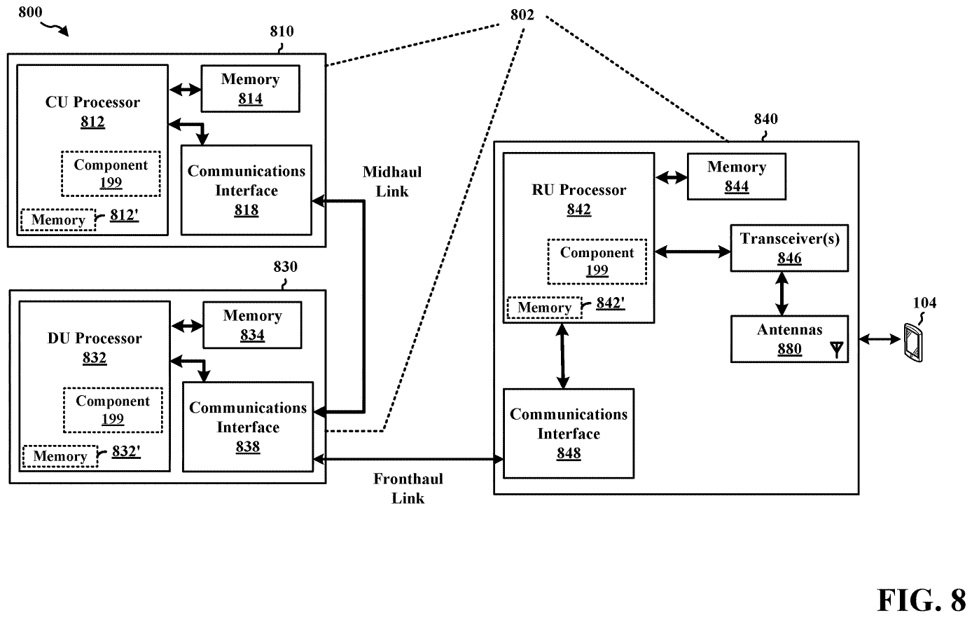

FIG. 8 is a diagram 800 illustrating an example of a hardware implementation for a network entity 802. The network entity 802 may be a BS, a component of a BS, or may implement BS functionality. The network entity 802 may include at least one of a CU 810, a DU 830, or an RU 840. For example, depending on the layer functionality handled by the component 199, the network entity 802 may include the CU 810; both the CU 810 and the DU 830; each of the CU 810, the DU 830, and the RU 840; the DU 830; both the DU 830 and the RU 840; or the RU 840. The CU 810 may include at least one CU processor 812. The CU processor(s) 812 may include on-chip memory 812′. In some aspects, the CU 810 may further include additional memory modules 814 and a communications interface 818. The CU 810 communicates with the DU 830 through a midhaul link, such as an F1 interface. The DU 830 may include at least one DU processor 832. The DU processor(s) 832 may include on-chip memory 832′. In some aspects, the DU 830 may further include additional memory modules 834 and a communications interface 838. The DU 830 communicates with the RU 840 through a fronthaul link. The RU 840 may include at least one RU processor 842. The RU processor(s) 842 may include on-chip memory 842′. In some aspects, the RU 840 may further include additional memory modules 844, one or more transceivers 846, antennas 880, and a communications interface 848. The RU 840 communicates with the UE 104. The on-chip memory 812′, 832′, 842′ and the additional memory modules 814, 834, 844 may each be considered a computer-readable medium/memory. Each computer-readable medium/memory may be non-transitory. Each of the processors 812, 832, 842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the conditional measurement component 199 may be configured to communicate, with a user equipment (UE), a conditional measurement configuration that indicates at least one measurement skipping condition or at least one measurement resume condition associated with at least one frequency portion. In some aspects, the conditional measurement component 199 may be further configured to transmit or skip transmission of, based on the at least one measurement skipping condition or the at least one measurement resume condition, at least one reference signal associated with at least one measurement in the at least one frequency portion. The conditional measurement component 199 may be within one or more processors of one or more of the CU 810, DU 830, and the RU 840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 802 may include a variety of components configured for various functions. In one configuration, the network entity 802 may include means for communicating, with a user equipment (UE), a conditional measurement configuration that indicates at least one measurement skipping condition or at least one measurement resume condition associated with at least one frequency portion. In some aspects, the network entity 802 may include means for transmitting or skipping transmission of, based on the at least one measurement skipping condition or the at least one measurement resume condition, at least one reference signal associated with at least one measurement in the at least one frequency portion. The means may be the component 199 of the network entity 802 configured to perform the functions recited by the means. As described supra, the network entity 802 may include the TX processor 316, the RX processor 370, and the controller/processor 375. As such, in one configuration, the means may be the TX processor 316, the RX processor 370, and/or the controller/processor 375 configured to perform the functions recited by the means.

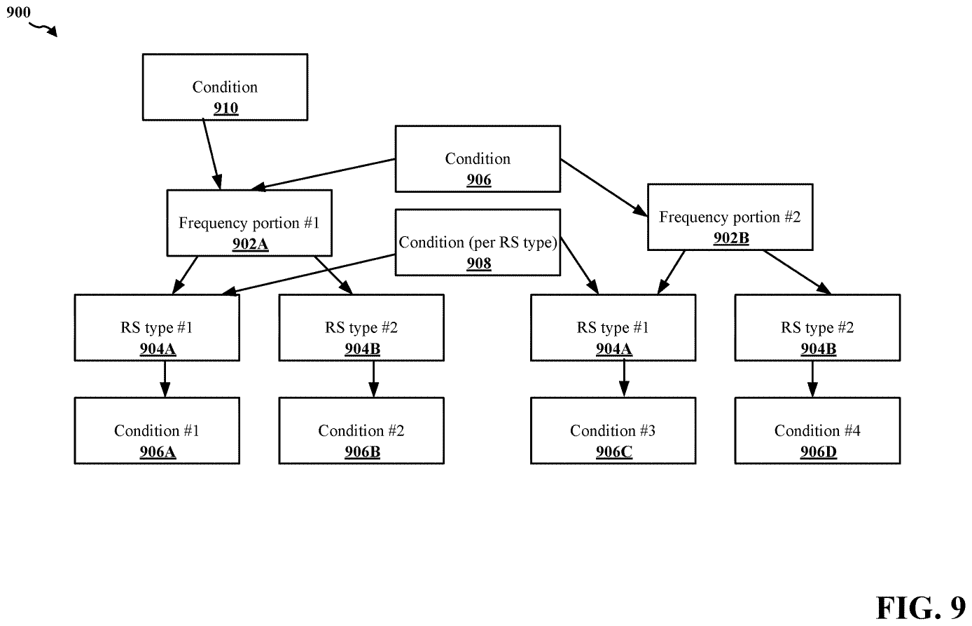

FIG. 9 is a diagram 900 illustrating an example of different conditions, different frequency portions, and different reference signal types, in accordance with various aspects of the present disclosure. As described herein, a measurement skipping condition or a measurement resume condition may be configured per frequency portion, per RS type, for all frequency portions, or for all RS types. As illustrated in FIG. 9, a first frequency portion 902A and a second frequency portion 902B are provided as examples. There may be a first RS type 904A and a second RS type 904B associated with each of the first frequency portion 902A and the second frequency portion 902B. A first example condition 906A (which may be a measurement skipping condition or a measurement resume condition) may be associated with skipping, reducing the measurement frequency of, or resume the measurement for the first RS type 904A of the frequency portion 902A. A second example condition 906B (which may be a measurement skipping condition or a measurement resume condition) may be associated with skipping, reducing the measurement frequency of, or resume the measurement for the second RS type 904B of the frequency portion 902A. A third example condition 906C (which may be a measurement skipping condition or a measurement resume condition) may be associated with skipping, reducing the measurement frequency of, or resume the measurement for the first RS type 904A of the frequency portion 902B. A fourth example condition 906D (which may be a measurement skipping condition or a measurement resume condition) may be associated with skipping, reducing the measurement frequency of, or resume the measurement for the second RS type 904B of the frequency portion 902B.

Another example condition 906 (which may be a measurement skipping condition or a measurement resume condition) may be associated with skipping, reducing the measurement frequency of, or resume the measurement for all RS types for both the frequency portion 902A and the frequency portion 902B. Another example condition 908 (which may be a measurement skipping condition or a measurement resume condition) may be associated with skipping, reducing the measurement frequency of, or resume the measurement for the first RS type 904A for both the frequency portion 902A and the frequency portion 902B. Another example condition 910 (which may be a measurement skipping condition or a measurement resume condition) may be associated with skipping, reducing the measurement frequency of, or resume the measurement for all RS types for the frequency portion 902A. Each of these conditions that may be per frequency portion, per RS type, for all frequency portions, or for all RS types may be separately configured or configured together (e.g., as part of a same conditional measurement configuration).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a first wireless device (e.g., a UE or a network node), including: at least one memory; and at least one processor coupled to the at least one memory, based at least in part on information stored in the at least one memory, the at least one processor is configured to: communicate, with a second wireless device (e.g., a network node or a UE), a conditional measurement configuration that indicates at least one measurement skipping condition or at least one measurement resume condition associated with at least one frequency portion; and skip or perform, based on the at least one measurement skipping condition or the at least one measurement resume condition, at least one measurement associated with at least one reference signal in the at least one frequency portion.

Aspect 2 is the apparatus of aspect 1, where the conditional measurement configuration includes the at least one measurement skipping condition, and where the at least one processor is further configured to: skip, based on the at least one measurement skipping condition, the at least one measurement associated with the at least one reference signal in the at least one frequency portion.

Aspect 3 is the apparatus of any of aspects 1-2, where the at least one processor is further configured to: receive a downlink communication or transmit an uplink communication in the at least one frequency portion.

Aspect 4 is the apparatus of any of aspects 1-3, where the at least one measurement skipping condition or the at least one measurement resume condition is based on at least one of: an accuracy or a sensitivity associated with the at least one measurement relative to a measurement frequency associated with the at least one frequency portion, one or more prior measurements associated with the at least one frequency portion, a quantity of a set of other measured frequency portions associated with first wireless device (e.g., a UE or a network node), a correlation between the at least one frequency portion and the set of other measured frequency portions associated with first wireless device (e.g., a UE or a network node), an estimation quality associated with the at least one measurement, or a UE status.

Aspect 5 is the apparatus of aspect 4, where first wireless device (e.g., a UE or a network node) status includes at least one of: an energy state associated with first wireless device (e.g., a UE or a network node), a mobility associated with first wireless device (e.g., a UE or a network node), an expected traffic at first wireless device (e.g., a UE or a network node), a quality of service associated with first wireless device (e.g., a UE or a network node), or a UE temperature status.

Aspect 6 is the apparatus of any of aspects 1-5, where the conditional measurement configuration includes the at least one measurement skipping condition, and where the at least one processor is further configured to: skip, based on the at least one measurement skipping condition, the at least one measurement associated with the at least one reference signal in the at least one frequency portion and perform at least one other measurement at a reduced frequency in the at least one frequency portion.

Aspect 7 is the apparatus of any of aspects 1-6, where the conditional measurement configuration includes the at least one measurement resume condition, and where the at least one processor is further configured to: resume, based on the at least one measurement resume condition, performance of the at least one measurement associated with the at least one reference signal in the at least one frequency portion.

Aspect 8 is the apparatus of any of aspects 1-7, where each measurement skipping condition of the at least one measurement skipping condition or each measurement resume condition of the at least one measurement resume condition is associated with at least one respective frequency portion of the at least one frequency portion or all of the at least one frequency portion, at least one respective reference signal type associated with the at least one reference signal, or an area associated with first wireless device (e.g., a UE or a network node).

Aspect 9 is the apparatus of aspect 8, where the at least one respective reference signal type corresponds to at least one of: a primary synchronization signal (PSS), a secondary reference signal (SSS), a channel state information reference signal (CSI-RS), a demodulation reference signal (DM-RS), a phase tracking reference signal (PTRS), a sounding reference signal (SRS), or a channel state information interference measurement (CSI-IM).

Aspect 10 is the apparatus of any of aspects 1-9, where each measurement skipping condition of the at least one measurement skipping condition or each measurement resume condition of the at least one measurement resume condition is specific to a respective area associated with first wireless device (e.g., a UE or a network node), a respective UE type, or a time period.

Aspect 11 is the apparatus of aspect 10, where the respective UE type corresponds to a mobile UE, a relay UE, an access point, an integrated access point (IAP), or a customer premises equipment (CPE).

Aspect 12 is the apparatus of any of aspects 1-11, where to communicate the conditional measurement configuration, the at least one processor is configured to: receive, from the second wireless device (e.g., a network node or a UE), the conditional measurement configuration in a system information block (SIB) or radio resource control (RRC) signaling.

Aspect 13 is the apparatus of aspect 12, where to communicate the conditional measurement configuration, the at least one processor is configured to: transmit, to the second wireless device (e.g., a network node or a UE) a capability indication that indicates a support associated with the at least one measurement skipping condition or the at least one measurement resume condition.

Aspect 14 is the apparatus of any of aspects 1-13, where to communicate the conditional measurement configuration, the at least one processor is configured to: transmit, to the second wireless device (e.g., a network node or a UE), a proposal for the conditional measurement configuration; and receive, from the second wireless device (e.g., a network node or a UE), a confirmation, a different proposal for the conditional measurement configuration, or a denial in response to the proposal.

Aspect 15 is the apparatus of any of aspects 1-14, where the conditional measurement configuration further includes at least one location of the at least one frequency portion and a mapping between the at least one location and at least one of: (1) the at least one measurement skipping condition or (2) the at least one measurement resume condition.

Aspect 16 is the apparatus of any of aspects 1-15, where the conditional measurement configuration further includes a quantity associated with the at least one frequency portion.

Aspect 17 is the apparatus of any of aspects 1-16, where the conditional measurement configuration further includes information associated with a derivation of the at least one frequency portion, where the information includes one or more frequency portions to be excluded from skipping, at least one measurement estimation threshold, at least one transmission parameter associated with the at least one reference signal, or at least one quality of service (QoS) indication.

Aspect 18 is the apparatus of any of aspects 1-17, where the at least one frequency portion includes at least one frequency component, at least one frequency subcomponent, at least one frequency band, or at least one frequency subband.

Aspect 19 is an apparatus for wireless communication at a second wireless device (e.g., a network node or a UE), including: at least one memory; and at least one processor coupled to the at least one memory, based at least in part on information stored in the at least one memory, the at least one processor is configured to: communicate, with a first wireless device (e.g., a UE or a network node), a conditional measurement configuration that indicates at least one measurement skipping condition or at least one measurement resume condition associated with at least one frequency portion; and transmit or skip transmission of, based on the at least one measurement skipping condition or the at least one measurement resume condition, at least one reference signal associated with at least one measurement in the at least one frequency portion.

Aspect 20 is a method of wireless communication for implementing any of aspects 1 to 19.

Aspect 21 is a computer-readable medium (e.g., a non-transitory computer-readable medium) storing computer executable code, the code when executed by at least one processor causes the at least one processor to implement any of aspects 1 to 19.

Aspect 22 is an apparatus comprising means for implementing any of aspects 1 to 19.

What is claimed is:

1. An apparatus for wireless communication at a user equipment (UE), comprising:
at least one memory; and
at least one processor coupled to the at least one memory, based at least in part on information stored in the at least one memory, the at least one processor is configured to:
communicate, with a network node, a conditional measurement configuration that indicates at least one measurement skipping condition or at least one measurement resume condition associated with at least one frequency portion; and
skip or perform, based on the at least one measurement skipping condition or the at least one measurement resume condition, at least one measurement associated with at least one reference signal in the at least one frequency portion.

2. The apparatus of claim 1, wherein the conditional measurement configuration includes the at least one measurement skipping condition, and wherein the at least one processor is further configured to:
skip, based on the at least one measurement skipping condition, the at least one measurement associated with the at least one reference signal in the at least one frequency portion.

3. The apparatus of claim 1, wherein the at least one processor is further configured to:
receive a downlink communication or transmit an uplink communication in the at least one frequency portion; and
skip the at least one measurement in the at least one frequency portion.

4. The apparatus of claim 1, wherein the at least one measurement skipping condition or the at least one measurement resume condition is based on at least one of: an accuracy or a sensitivity associated with the at least one measurement relative to a measurement frequency associated with the at least one frequency portion, one or more prior measurements associated with the at least one frequency portion, a quantity of a set of other measured frequency portions associated with the UE, a correlation between the at least one frequency portion and the set of other measured frequency portions associated with the UE, an estimation quality associated with the at least one measurement, or a UE status.

5. The apparatus of claim 4, wherein the UE status comprises at least one of: an energy state associated with the UE, a mobility associated with the UE, an expected traffic at the UE, a quality of service associated with the UE, or a UE temperature status.

6. The apparatus of claim 1, wherein the conditional measurement configuration includes the at least one measurement skipping condition, and wherein the at least one processor is further configured to:
skip, based on the at least one measurement skipping condition, the at least one measurement associated with the at least one reference signal in the at least one frequency portion and perform at least one other measurement at a reduced frequency in the at least one frequency portion.

7. The apparatus of claim 1, wherein the conditional measurement configuration includes the at least one measurement resume condition, and wherein the at least one processor is further configured to:
resume, based on the at least one measurement resume condition, performance of the at least one measurement associated with the at least one reference signal in the at least one frequency portion.

8. The apparatus of claim 1, wherein each measurement skipping condition of the at least one measurement skipping condition or each measurement resume condition of the at least one measurement resume condition is associated with at least one respective frequency portion of the at least one frequency portion or all of the at least one frequency portion, at least one respective reference signal type associated with the at least one reference signal, or an area associated with the UE.

9. The apparatus of claim 8, wherein the at least one respective reference signal type corresponds to at least one of: a primary synchronization signal (PSS), a secondary reference signal (SSS), a channel state information reference signal (CSI-RS), a demodulation reference signal (DM-RS), a phase tracking reference signal (PTRS), a sounding reference signal (SRS), or a channel state information interference measurement (CSI-IM).

10. The apparatus of claim 1, wherein each measurement skipping condition of the at least one measurement skipping condition or each measurement resume condition of the at least one measurement resume condition is specific to a respective area associated with the UE, a respective UE type, or a time period.

11. The apparatus of claim 10, wherein the respective UE type corresponds to a mobile UE, a relay UE, an access point, an integrated access point (IAP), or a customer premises equipment (CPE).

12. The apparatus of claim 1, wherein to communicate the conditional measurement configuration, the at least one processor is configured to:
receive, from the network node, the conditional measurement configuration in a system information block (SIB) or radio resource control (RRC) signaling.

13. The apparatus of claim 12, wherein to communicate the conditional measurement configuration, the at least one processor is configured to:
transmit, to the network node a capability indication that indicates a support associated with the at least one measurement skipping condition or the at least one measurement resume condition.

14. The apparatus of claim 1, wherein to communicate the conditional measurement configuration, the at least one processor is configured to:
transmit, to the network node, a proposal for the conditional measurement configuration; and
receive, from the network node, a confirmation, a different proposal for the conditional measurement configuration, or a denial in response to the proposal.

15. The apparatus of claim 1, wherein the conditional measurement configuration further comprises at least one location of the at least one frequency portion and a mapping between the at least one location and at least one of: (1) the at least one measurement skipping condition or (2) the at least one measurement resume condition.

16. The apparatus of claim 1, wherein the conditional measurement configuration further comprises a quantity associated with the at least one frequency portion.

17. The apparatus of claim 1, wherein the conditional measurement configuration further comprises information associated with a derivation of the at least one frequency portion, wherein the information associated with the derivation comprises one or more frequency portions to be excluded from skipping, at least one measurement estimation threshold, at least one transmission parameter associated with the at least one reference signal, or at least one quality of service (QoS) indication.

18. The apparatus of claim 1, wherein the at least one frequency portion comprises at least one frequency component, at least one frequency subcomponent, at least one frequency band, or at least one frequency subband.

19. An apparatus for wireless communication at a network node, comprising:
at least one memory; and
at least one processor coupled to the at least one memory, based at least in part on information stored in the at least one memory, the at least one processor is configured to:
communicate, with a user equipment (UE), a conditional measurement configuration that indicates at least one measurement skipping condition or at least one measurement resume condition associated with at least one frequency portion; and
transmit or skip transmission of, based on the at least one measurement skipping condition or the at least one measurement resume condition, at least one reference signal associated with at least one measurement in the at least one frequency portion.

20. A method for wireless communication performed by a user equipment (UE), comprising:
communicating, with a network node, a conditional measurement configuration that indicates at least one measurement skipping condition or at least one measurement resume condition associated with at least one frequency portion; and
skipping or performing, based on the at least one measurement skipping condition or the at least one measurement resume condition, at least one measurement associated with at least one reference signal in the at least one frequency portion.
